(19) United States
(12) Patent Application Publication
(10) Pub. No.: US 2018/0032118 A1
(43) Pub. Date: Feb. 1, 2018

(54) CONTROL METHOD, EXTENSION DEVICE, AND RECORDING MEDIUM

(71) Applicant: FUJITSU LIMITED, Kawasaki-shi (JP)

(72) Inventors: Tatsuya SHIMURA, Kawasaki (JP); Akira MORITA, Kawasaki (JP); Taketoshi HAYASHI, Nagoya (JP)

(73) Assignee: FUJITSU LIMITED, Kawasaki-shi (JP)

(21) Appl. No.: 15/642,640

(22) Filed: Jul. 6, 2017

(30) Foreign Application Priority Data
Jul. 27, 2016 (JP) 2016-147783

(51) Int. Cl. G06F 1/26; G06F 13/38; G06F 1/32; G06F 13/40; G06F 13/42

(52) U.S. Cl. CPC G06F 1/266; G06F 13/4068; G06F 13/4282; G06F 1/3287; G06F 1/3212; G06F 13/385; G06F 2213/0042

(57) ABSTRACT

A control method executed by a processor included in an extension device, the control method includes executing power supply to another device via a connector using a battery provided in the extension device while power supply to the extension device is not executed; stopping power supply to the other device when it is detected that a terminal device coupled to the extension device and different from the another device is turned on, or that the terminal device turned on is coupled to the extension device; and starting power supply to the extension device while power supply to the other device is stopped.

### CROSS-REFERENCE TO RELATED APPLICATION

This application is based upon and claims the benefit of priority of the prior Japanese Patent Application No. 2016-147783, filed on Jul. 27, 2016, the entire contents of which are incorporated herein by reference.

### FIELD

The embodiments discussed herein are related to a control method, an extension device, and a recording medium.

### BACKGROUND

In recent years, tablet type and portable type terminal devices have been compacted and thinned so that a user can carry such devices easily. In this case, a terminal device does not have extension functions such as an external interface, such functions are provided in an extension device such as a cradle or a docking station, and the terminal device is connected to the extension device to allow a user to use the functions that the extension device has in the terminal device. Known is a sleep-and-charge technique of charging a Universal Serial Bus (USB) device through a USB terminal that an extension device includes in a state in which of a terminal device is turned off (refer to, for example, Japanese Laid-open Patent Publication No. 2011-134126).

However, there are cases in which it is not possible to normally recognize a USB device when a terminal device connected to an extension device is activated, an activated terminal device is connected to an extension device, or the like, during power supply from a USB terminal. It is preferable that it be possible, during power supply from a USB terminal, to connect normally when a terminal device connected to an extension device is activated, or when an activated terminal device is connected to an extension device.

### SUMMARY

According to an aspect of the invention, a control method executed by a processor included in an extension device, the control method includes executing power supply to another device via a connector using a battery provided in the extension device while power supply to the extension device is not executed; stopping power supply to the other device when it is detected that a terminal device coupled to the extension device and different from the another device is turned on, or that the terminal device turned on is coupled to the extension device; and starting power supply to the extension device while power supply to the other device is stopped.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view that illustrates an example of a system of a portable terminal and a cradle according to an embodiment;

FIG. 2 is a view that illustrates an example of a hardware configuration of the portable terminal and the cradle according to the embodiment;

FIG. 3 is a view that illustrates an example of a functional configuration of the portable terminal and the cradle according to the embodiment;

FIG. 4 is a view that illustrates a state of a GPIO signal according to the embodiment;

FIG. 5 is a correspondence view of the state of the power of the portable terminal and an ACPI state according to the embodiment;

FIGS. 6A and 6B are views for describing GPIO signal control according to the embodiment;

FIG. 7 is a state transition view of the cradle according to the embodiment;

FIGS. 8A to 8C are views for describing signal control in each case of state transitions according to the embodiment;

FIGS. 9A and 9B are views for describing signal control in each case of state transitions according to the embodiment; and

FIGS. 10 A and 10B are flowcharts that illustrate an example of a GPIO signal control process according to the embodiment.

### DESCRIPTION OF EMBODIMENTS

Hereinafter, an embodiment of the present disclosure will be described with reference to the drawings. In the present specification and drawings, constituent elements having substantially the same functional configurations will be given the same reference symbols, and overlapping description thereof will be omitted.

Terminal devices have been compacted and thinned so that a user can carry such devices easily. Therefore, extension functions are provided in an extension device such as a cradle or a docking station, and a terminal device is connected to an extension device to allow a user to use the functions that the extension device has in the terminal device.

There are cases in which a terminal device is equipped with a function of supplying power to another device (a USB device) from a USB terminal (a USB connector) when the terminal device is turned off and in a shut-down or sleep state. Such a function is realized by continuing the supply of power to a VBUS connected to a USB terminal even in a state in which the terminal device is turned off state. In recent years, due to the convenience of this function, in addition to terminal devices, extension devices such as docking stations, which are attached and detached thereto, have also been equipped with the function. In the present embodiment, this function will also be referred to as “power off USB charging”.

However, in a case in which power off USB charging is active, though the power of a USB host controller equipped with the terminal device is not on, the USB device is turned on. When a terminal device connected to an extension device is turned on in this state, there are often cases in which it is not possible for the USB host controller to normally recognize the USB device. This is caused by discordance of the power states in which “a USB device is turned on while the power of the USB host controller is not on” as described above.

In a case in which a cradle has a power off USB charging function, power supply from a USB terminal is performed even in a state of a cradle alone in which a terminal device is not docked. In a system in which a terminal device is docked in a cradle and which performs communication between the two devices, even in an unstable state, which is not a state in which the terminal device and the cradle are reliably connected (hereinafter, referred to as a “docked state”), such as when a terminal device is merely placed on top of a cradle, as long as there is a state of merely touching a terminal used in data communication between the terminal device and the cradle, a USB host controller recognizes a USB device connected to a USB terminal of the cradle.

However, if a USB device is recognized in an unstable docked state, it is easy to transition from the docked state to an undocked state (an unconnected state). Therefore, there is a high probability that a device will become separated at an unintended timing and that data loss and device failure will occur.

In the present embodiment, an extension device and a terminal device are connected normally when a terminal device connected to the extension device is activated during power supply from a USB terminal, and when an activated terminal device is connected to the extension device during power supply from the USB terminal. As a result of this, a system capable of normally recognizing a USB device is provided. In the present embodiment, a system capable of avoiding the occurrence of data loss due to unprepared separation is provided by configuring such that a USB device is not detected in an unstable signal connection state between a terminal device and an extension device.

In the present embodiment, a GPIO2 signal, which will be mentioned later, is, for example, used as a reset signal or a disabling signal for fixing to a state in which devices involved in USB connection are not activated (or in other words, a reset state or a disabling state). As a result of this, it is possible to suppress recognition of a USB device in an unstable docked state. In the following explanation, description will be given using power supply from a USB terminal as an example. However, a USB terminal is an example of a peripheral equipment connection terminal capable of power supply. Other examples of a peripheral equipment connection terminal include Lightning (registered trademark).

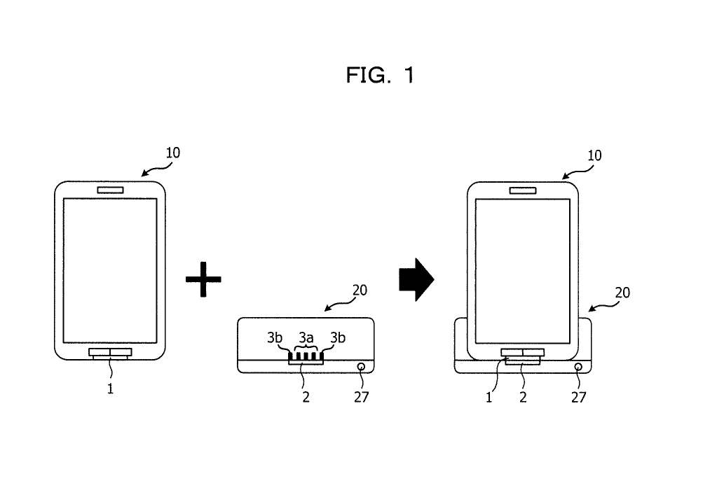

First, a configuration of a system according to the embodiment of the present disclosure will be described with reference to FIG. 1. The system according to the present embodiment includes a portable terminal 10 and a cradle 20 for which connector connection is possible by using dock connectors 1 and 2. In the system, the portable terminal 10 can use a power supply function or an extension function that the cradle 20 has as a result of the portable terminal 10 being docked in the cradle 20, which functions as a platform.

The portable terminal 10 is an example of a terminal device capable of coupling with an extension device. The terminal device is not limited to the portable terminal 10, and may be a personal computer (PC), a tablet type terminal, a smartphone, a video camera, a digital camera, a personal digital assistant (PDA), a portable music playback device, a portable video processing device, a portable game device, or a wearable display device such as a head mount display (HMD).

The cradle 20 is an example of an extension device that has a power off USB charging function and extends the functions of the portable terminal 10. The extension device is not limited to the cradle 20, and may be an attachment device such as a charger capable of coupling with the portable terminal 10.

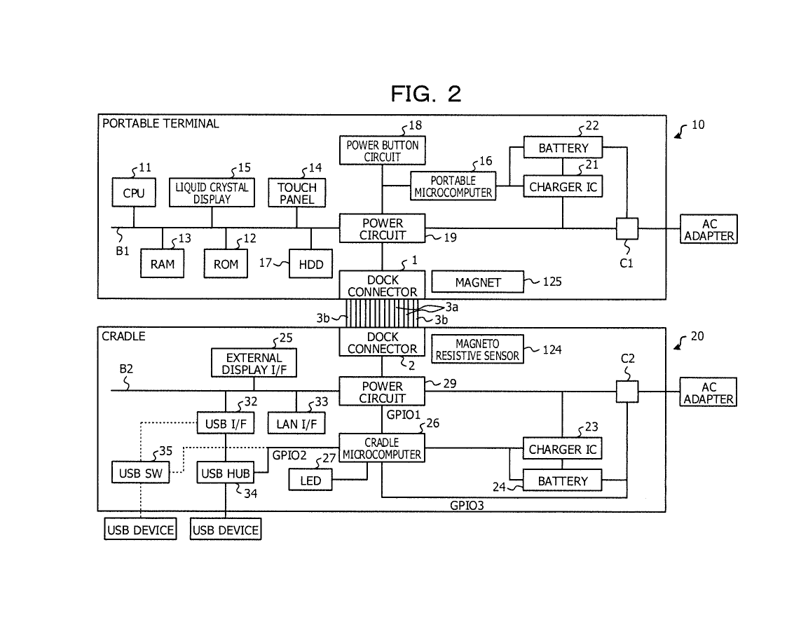

An example of hardware configurations of the portable terminal 10 and the cradle 20 according to the present embodiment will be described with reference to FIG. 2. As illustrated in FIG. 2, the portable terminal 10 and the cradle 20 are respectively capable of being connected to alternating current (AC) adapters, and can mutually perform power supply to one another. The portable terminal 10 and the cradle 20 are respectively equipped with general-purpose embedded controllers (ECs), and serial communication between the ECs is possible during dock connection. In FIG. 2, the general-purpose EC of the portable terminal 10 is a portable microcomputer 16. The general-purpose EC of the cradle 20 is a cradle microcomputer 26.

As a result of this, it is possible to mutually perform notification of information on the portable terminal 10 side (a main body side) and information on the cradle 20 side (a dock side), and therefore, functional extensions that use this information are possible.

The portable terminal 10 and the cradle 20 can be physically coupled by using the dock connector 2 on the cradle 20 side and the dock connector 1 on the portable terminal 10 side. Electrical connection is possible as a result of connection terminals 3a and 3b of the dock connector 2 on the cradle 20 side coming into contact with a contact point of the dock connector 1. The dock connector 2 and the connection terminals 3a and 3b on the cradle 20 side are also referred to as a coupling portion 3.

The portable terminal 10 includes a central processing unit (CPU) 11, a read only memory (ROM) 12, a random access memory (RAM) 13, a touch panel 14, a liquid crystal display 15, the portable microcomputer 16, a hard disk drive (HDD) 17, a power button circuit 18, a power circuit 19, a charger IC 21, a battery 22, an alternating current (AC) connector C1, a magnet 125, and the dock connector 1. The CPU 11, the ROM 12, the RAM 13, the touch panel 14, the liquid crystal display 15, the portable microcomputer 16, the HDD 17, the power button circuit 18, the power circuit 19, and the dock connector 1 are connected by a connection bus B1.

The HDD 17 stores various programs and various data in recording medium in a freely readable/writable manner. An operating system (OS), a GPIO signal control process program, and various tables are stored in the HDD 17. In place of the HDD 17, for example, the programs and various tables may also be stored in a cloud system storage device, which is a computer group on a network. In place of the HDD 17, for example, erasable programmable ROM (EPROM), or a solid state drive (SSD) can be used. For example, a compact disc (CD) drive device, a digital versatile disc (DVD) drive device, or a Blu-ray (registered trademark) disc (BD) drive device can be used. Network attached storage (NAS) or a storage area network (SAN) may also be used.

The CPU 11 performs control of the portable terminal 10 by executing programs as a result of writing a predetermined program to a work region of the RAM 13 from the HDD 17 in which various programs and various data is stored.

The touch panel 14 receives touch operation from a user. Data processed by the CPU 11 and data stored in the ROM 12 or the RAM 13 is output to the liquid crystal display 15. For example, the liquid crystal display 15 is a liquid crystal display (LCD), a plasma display panel (PDP), an electroluminescence (EL) panel, an organic EL panel, or the like.

The portable microcomputer 16 includes an arithmetic circuit and a storage device, and executes a communication process with the cradle 20, a power supply process, and the like. The portable microcomputer 16 acquires voltage values of the connection terminals 3b of both ends. The voltages applied to the connection terminals 3b are adjusted so as to be kept in a certain range in a case of docking. Accordingly, the portable microcomputer 16 determines a docked state if the voltage values of the connection terminals 3b are within the certain range, and an undocked state if outside the range. As a result of this, it is possible to detect a connection state of the portable terminal 10 and the cradle 20.

The portable microcomputer 16 can mutually perform serial communication with the cradle microcomputer 26 on the cradle 20 side while dock connection of the portable terminal 10 and the cradle 20 is established by the dock connectors 1 and 2. As a result of this, it is possible to ascertain the state of a corresponding cradle 20, to transmit instruction signals to the cradle microcomputer 26 from the portable microcomputer 16, and the like.

The dock connector 1 is provided with a plurality of contact points that are formed to be planar surfaces and with which the plurality of connection terminals 3a and 3b that the dock connector 2 is provided with come into contact. Electrical connection is achieved as a result of the connection terminals 3a and 3b coming into contact with the plurality of contact points. Further, communication between the portable terminal 10 and the cradle 20 is possible. Power supply from one of the portable terminal 10 and the cradle 20 to the other is possible.

The charger IC 21, the battery 22, and the portable microcomputer 16 are connected to the AC adapter via the AC connector C1. When a power button provided in the portable terminal 10 is pressed down, the power button performs transmission to the portable microcomputer 16 via the power button circuit 18. Further, power is supplied from the AC adapter side connected to the AC connector C1 to the each portion via the power circuit 19. Power may be supplied from the battery 22 due to the control of the charger IC 21.

The cradle 20 includes an external display interface (I/F) 25, the cradle microcomputer 26, an LED 27, a power circuit 29, a USB interface (I/F) 32, a local area network (LAN) interface (I/F) 33, a USB hub 34, a USB switch 35, a charger IC 23, a battery 24, an AC connector C2, a magneto resistive (MR) sensor 124, and the dock connector 2. The external display I/F 25, the USB I/F 32, the LAN I/F 33, the cradle microcomputer 26, the power circuit 29, and the dock connector 2 are connected by a connection bus B2. The LED 27 and the magneto resistive sensor 124 are connected to the cradle microcomputer 26.

The external display I/F 25, the USB I/F 32, and the LAN I/F 33 are interfaced with external devices. External devices connected to the external display I/F 25, the USB I/F 32, and the LAN I/F 33 can be used from the portable terminal 10 connected to the cradle 20. For example, a USB device connected to the USB hub 34 and the USB switch 35 can be used from the portable terminal 10 connected to the cradle 20. It is sufficient as long as at least one of the USB hub 34 and the USB switch 35 is provided in the cradle 20.

The dock connector 2 can transmit and receive communication and power between the portable terminal 10 and the cradle 20 by electrically connecting both components as a result of connecting to the dock connector 1 on the portable terminal 10.

The cradle microcomputer 26 includes an arithmetic circuit and a storage device. The cradle microcomputer 26 acquires the voltage values of the connection terminals 3b of both ends, and detects the docked state if the voltages are within the certain range, and detects the undocked state if outside the range. As a result of this, it is possible to determine a connection state of the portable terminal 10 and the cradle 20. As long as the portable microcomputer 16 and the cradle microcomputer 26 can detect physical docking and undocking, the method thereof is not limited. For example, physical docking and undocking may be detected using sensors such as the magneto resistive sensor 124.

The cradle microcomputer 26 can perform the notification and acquisition of information related to the connection state by communicating with the portable microcomputer 16 of the portable terminal 10 via the dock connector 2.

The charger IC 23, the battery 24, and the cradle microcomputer 26 are connected to the AC adapter via the AC connector C2. Power is supplied from the AC adapter side connected to the AC connector C2 to the each portion of the cradle 20 via the power circuit 29. Power may be supplied from the battery 24 to each portion of the cradle 20 due to the control of the charger IC 23. The AC adapter being connected to the cradle 20 side and the AC adapter being disconnected from the cradle 20 side are indicated by using HIGH or LOW of a GPIO3 signal that the cradle microcomputer 26 controls.

In a state in which the portable terminal 10 is turned off, the cradle 20 according to the present embodiment can perform power supply from the AC adapter or the battery side passing through a VBUS connected to USB terminals of the USB hub 34 and the USB switch 35 via the USB I/F 32. That is, the cradle 20 has a function of power off USB charging.

The magneto resistive sensor 124 is a sensor that uses a magneto resistive element in which the electrical resistance changes as a result of a magnetic field. The magneto resistive sensor 124 detects proximity of the portable terminal 10 and the cradle 20 by detecting a magnetic field from the magnet 125 provided in the portable terminal 10. The magneto resistive sensor 124 may also be provided in the portable terminal 10, and the magnet 125 may be provided in the cradle 20. In place of providing the magneto resistive sensor 124 and the magnet 125, for example, proximity of the portable terminal 10 and the cradle 20 may be detected by a proximity sensor, or the like.

According to such a configuration, in the present embodiment, the function of power off USB charging that the cradle 20 has is controlled by the cradle microcomputer 26. There are cases in which the cradle microcomputer 26 performs the control by receiving an instruction from the portable microcomputer 16, and there are cases in which the cradle microcomputer 26 performs the control in an autonomous manner.

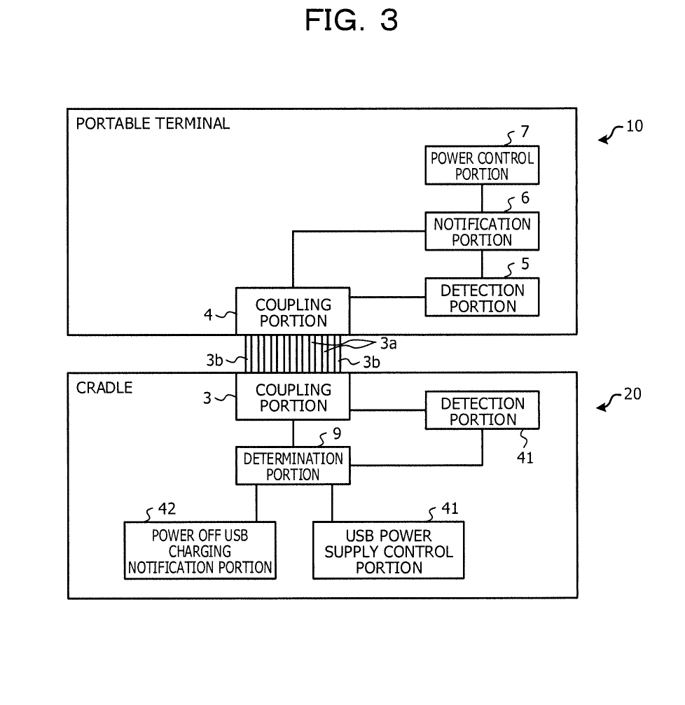

Next, an example of functional configurations of the portable terminal 10 and the cradle 20 according to the present embodiment will be described with reference to FIG. 3. The cradle 20 includes the coupling portion 3, a detection portion 8, a determination portion 9, a USB power supply control portion 41, and a power off USB charging notification portion 42.

The coupling portion 3 can perform serial communication and power supply with the portable terminal 10 as a result of coupling with a coupling portion 4 on the portable terminal 10 side. For example, the function of the coupling portion 3 is realized by the dock connector 2 and the connection terminals 3a and 3b. The coupling portion 4 on the portable terminal 10 side is an example of a first coupling portion. The coupling portion 3 on the cradle 20 side is an example of a second coupling portion.

The detection portion 8 detects whether or not the portable terminal 10 is coupled with (docked in) the cradle 20. The detection portion 8 detects that the portable terminal 10 connected to the cradle 20 is turned on. The determination portion 9 determines whether or not conditions under which it is possible to execute power off USB charging are satisfied.

If it is detected that an activated portable terminal 10 is connected to the cradle 20 or the portable terminal 10 connected to the cradle 20 is activated, the power off USB charging notification portion 42 notifies the USB power supply control portion 41 of the detection of an activated portable terminal 10 being connected to the cradle 20 or detection of the portable terminal 10 connected to the cradle 20 being activated. The USB power supply control portion 41 stops power supply to a USB device from USB terminals of the USB hub 34 and the USB switch 35 in accordance with the notifications of the detection.

The USB power supply control portion 41 supplies power to the cradle 20 after stopping power supply to a USB device from the USB terminals. The USB power supply control portion 41 restarts power supply to a USB device from the USB terminals after power is supplied to the cradle 20.

For example, the functions of the detection portion 8, the determination portion 9, the USB power supply control portion 41, and the power off USB charging notification portion 42 are realized by the cradle microcomputer 26.

The portable terminal 10 includes the coupling portion 4, a detection portion 5, a notification portion 6, and a power control portion 7. The coupling portion 4 can perform serial communication and power supply with the cradle 20 as a result of coupling with the coupling portion 3 of the cradle 20. For example, the function of the coupling portion 4 is realized by the dock connector 1 and the plurality of contact points provided in the dock connector 1.

The detection portion 5 detects whether or not the portable terminal 10 is coupled with the cradle 20. The power control portion 7 detects whether or not the portable terminal 10 is turned on based on an ACPI state. The notification portion 6 makes notification that the portable terminal 10 connected to the cradle 20 is turned on. The detection portion 8 detects that the portable terminal 10 connected to the cradle 20 is turned on as a result of a notification from the notification portion 6. For example, the functions of the detection portion 5, the notification portion 6, and the power control portion 7 are realized by the portable microcomputer 16.

FIG. 3 illustrates a block diagram focusing on functions. Each portion illustrated in the functional blocks can be realized by hardware only, software only, or a combination of hardware and software.

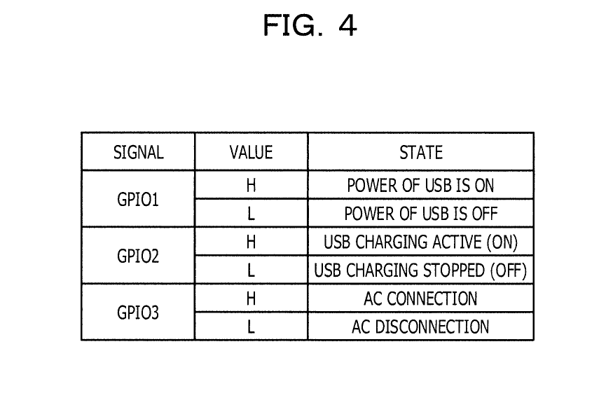

Signals of GPIO1 to GPIO3 will be described below. As illustrated in FIG. 2, the cradle microcomputer 26 controls a signal of GPIO1 for indicating whether or not the power of USB is on, that is, whether or not power supply to a VBUS is being performed. As illustrated in FIG. 4, when a GPIO1 signal is HIGH, the power of USB is on, and power supply to a VBUS is being performed. When the GPIO1 signal is LOW, the power of USB is off, and power supply to a VBUS is not being performed.

As illustrated in FIG. 2, the cradle microcomputer 26 controls a signal of GPIO2 for indicating to the outside whether or not the function of power off USB charging is active. As illustrated in FIG. 4, when a GPIO2 signal is HIGH, power off USB charging is active (on), and when the GPIO2 signal is LOW, power off USB charging is stopped (off). While power off USB charging is active, it is not possible to recognize a USB device since the CPU 11 of the portable terminal 10 is stopped, and it is not preferable to perform recognition in the first place. Accordingly, while power off USB charging is active, for example, the GPIO2 signal is used as a reset signal or a disable signal for fixing to a state in which devices involved in USB connection are not activated (or in other words, a reset state or a disabling state).

A notification method to devices involved in USB connection is not limited to a GPIO signal, and if the devices have a communication bus I/F, that can be used. However, the above-mentioned GPIO signal is used in a notification method to devices in the present embodiment.

Relating to a signal of GPIO3, as illustrated in FIG. 4, when a GPIO3 signal is HIGH, an AC adapter is connected to the cradle 20 side. On the other hand, when the GPIO3 signal is LOW, the AC adapter has been disconnected from the cradle 20 side.

However, the correspondence relationships of the values of the GPIO1 to GPIO3 signals and the states are not limited to the relationships illustrated in FIG. 4, and may be the reverse. For example, definition may be performed so that the power of USB is off when the GPIO1 signal is HIGH and the power of USB is on when the GPIO1 signal is LOW.

In the present embodiment, a state in which power off USB charging is active in a practical sense is attained when the GPIO1 signal and the GPIO2 signal are both on. Cases in which this condition is satisfied are as follows.

(1) A case in which the cradle microcomputer 26 detects that an AC adapter is connected to the cradle 20 side by using the GPIO3 signal when the cradle 20 is in a state in which a terminal device is not docked (an undocked state)

(2) A case in which it is detected that an AC adapter is connected to the cradle 20 side by using the GPIO3 signal when the portable terminal 10 and the cradle 20 are connected (a docked state), and the state of the advanced configuration and power interface (ACPI) of the portable terminal 10 is any one of G3, S5, or S4 (shut-down or in hibernation)

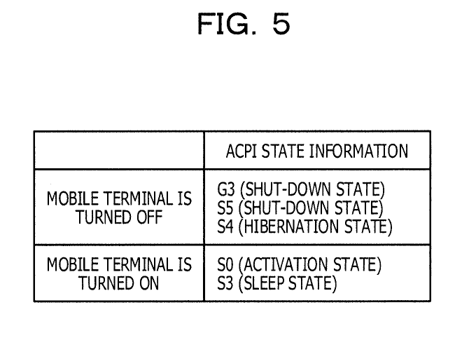

The portable terminal 10 manages ACPI state information of the portable terminal 10. The cradle microcomputer 26 is notified of ACPI state information from the portable microcomputer 16 by using inter-integrated circuit (I2C) communication between the portable microcomputer 16 and the cradle microcomputer 26. In the present embodiment, as illustrated in FIG. 5, in a case in which the ACPI state information is any one of G3, S5, or S4, the portable terminal 10 is turned off. In a case in which the ACPI state information is S0 or S3 (an active or sleep state), it is indicated that the portable terminal 10 is turned on.

(1) Control Specifications of GPIO1 Signal

The GPIO1 signal is a signal that controls a USB power (or in other words, power supply to a VBUS). The power circuit 29 is notified of HIGH (on) during an ACPI state (S0/S3) in which it is preferable to supply power to a USB device, or when power off USB charging is active. Conversely, the GPIO1 signal is set to non-notification (off) when it is not preferable to perform power supply to a USB.

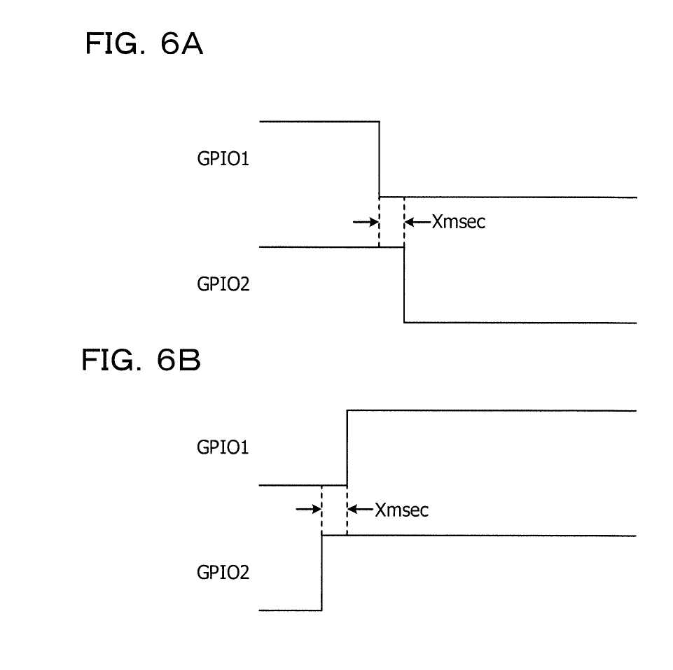

In the present embodiment, in a case of transitioning to a state in which it is preferable to correctly recognize a USB device in a state in which a USB power is on by power off USB charging, as illustrated in FIG. 6A, first, the GPIO1 signal becomes LOW from HIGH. Thereafter (after Xmsec), the GPIO2 signal becomes LOW from HIGH, and subsequently, when power is supplied due to the GPIO1 signal becoming high, it is possible to activate the USB hub 34 or the USB switch 35 after the supply of power to a VBUS is stopped. Thereafter, the GPIO1 is set on after preferable processes related to state transition are executed. “Xmsec” is a time to be adjusted in an individual manner by a system configuration.

(2) Control Specifications of GPIO2 Signal

The GPIO2 signal is a signal that indicates whether or not power off USB charging is active. The GPIO2 signal is connected to respective reset signals and enable signals for fixing to a state in which the USB hub 34 and the USB switch 35 are not activated when power off USB charging is active. As a result of this, for example, it is possible to set a state in which the USB hub 34 and the USB switch 35 are not activated since power off USB charging is active (on) when the GPIO2 signal is HIGH, and a state in which the activation of power off USB charging is stopped (off) and the USB hub 34 and the USB switch 35 can be activated when the GPIO2 signal is LOW. When the GPIO2 signal is HIGH, since power off USB charging is active (on), a state in which the USB hub 34 and the USB switch 35 are not activated is attained. Conversely, when the GPIO2 signal is LOW, the activation of power off USB charging is stopped (off) and a state in which the USB hub 34 and the USB switch 35 can be activated is attained.

In the present embodiment, when the GPIO1 signal for power off USB charging is set to HIGH, as illustrated in FIG. 6B, first, the GPIO2 signal changes from LOW to HIGH. As a result of this, a state in which the USB hub 34 and the USB switch 35 are not activated is attained. Thereafter (after Xmsec), the GPIO1 signal changes from LOW to HIGH. As a result of this, it is possible to stop activation of the USB hub 34 and the USB switch 35 before power is supplied to a VBUS.

In the present embodiment, the GPIO2 signal is controlled to be LOW during any one of the following condition 1 to condition 3.
Condition 1

The GPIO2 signal is controlled to be LOW when the GPIO1 signal is set to be LOW after the GPIO1 signal is set to be HIGH to activate power off USB charging (refer to 9B).
Condition 2

The GPIO2 signal is controlled to be LOW when an AC adapter on the cradle 20 side is disconnected.
Condition 3

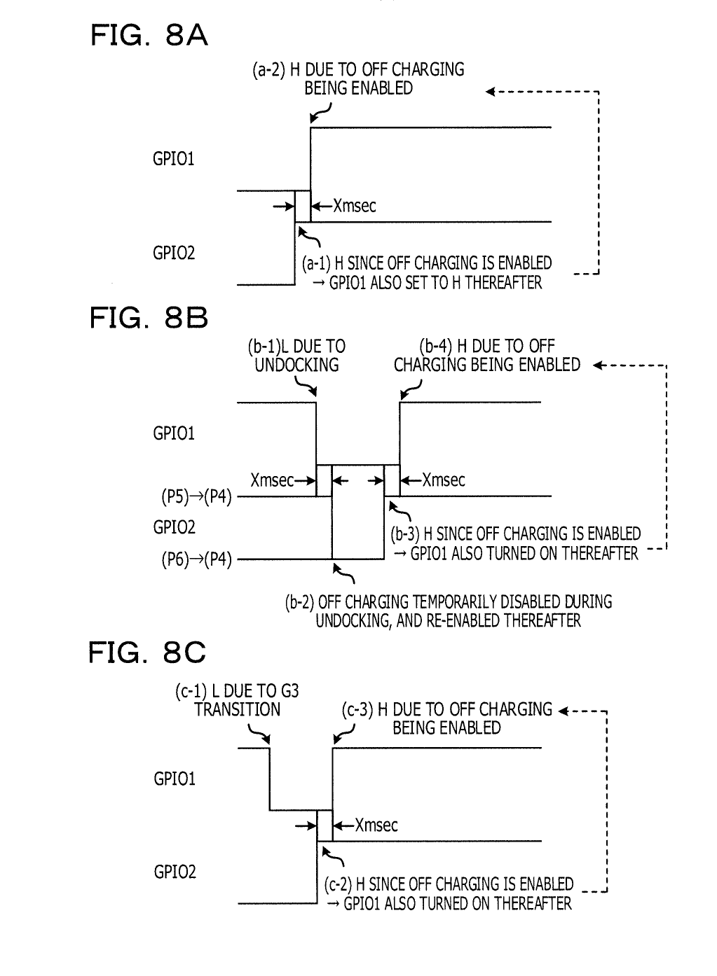

The GPIO2 signal is temporarily controlled to be LOW during undocking of the portable terminal 10 and the cradle 20. As a result of this, it is possible to temporarily disable power off USB charging during undocking (refer to FIG. 8B). In this case, as illustrated in FIG. 6A, the GPIO2 signal is controlled to be LOW after the GPIO1 signal is first controlled to be LOW.

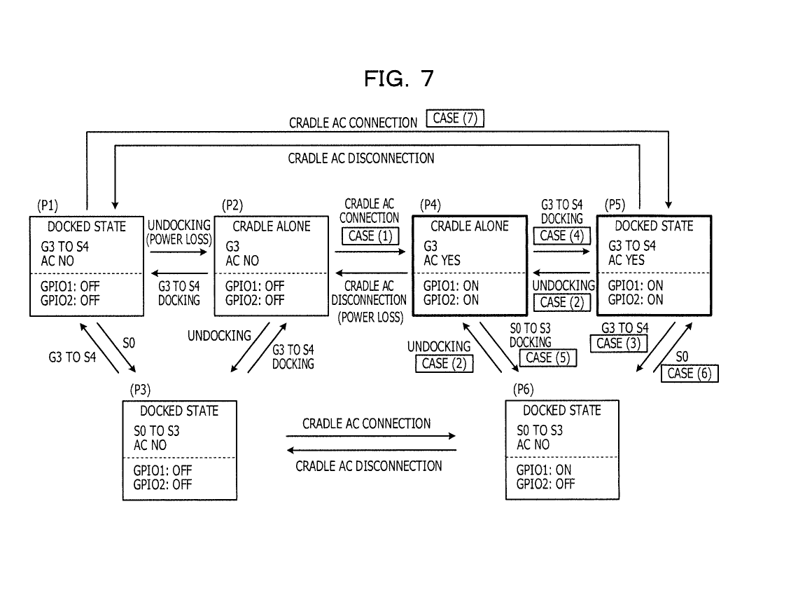

Next, control timing of the GPIO1 signal and the GPIO2 signal in respective cases 1 to 7 that correspond to state transitions will be described with reference to the state transition view of the cradle 20 in FIG. 7.

The states illustrated by the boxes (P2) and (P4) are undocked states of the cradle 20 and the portable terminal 10. The states illustrated by the other boxes are docked states of the cradle 20 and the portable terminal 10. In particular, (P4) and (P5) are states in which power off USB charging is enabled (active), and are illustrated using thick-bordered boxes.

First, the states inside the boxes will be described, and (P1) is a docked state. In (P1), the ACPI state of the portable terminal 10 is G3, S5, or S4, that is, the portable terminal 10 is turned off. The cradle 20 is in a state that is not connected to an AC adapter. In this case, the GPIO1 signal is set to LOW (off), which indicates the USB is turned off. Further, the GPIO2 signal is set to LOW (off), which indicates that power off USB charging is disabled (activation is stopped).

(P2) is a case of transitioning to an undocked state from the state of (P1). In (P2), the ACPI state of the portable terminal 10 is G3, that is, is in a shut-down state, and the cradle 20 is in a power loss state of not being connected to an AC adapter. In this case, the GPIO1 signal is set to LOW (off), which indicates the USB is turned off. Further, the GPIO2 signal is set to LOW (off), which indicates that power off USB charging is disabled. A transition to (P1) from the state of (P2) occurs in a case in which a portable terminal 10 in which the ACPI state is G3, S5, or S4 is docked.

A transition to (P3) from the state of (P2) occurs in a case in which a portable terminal 10 in which the ACPI state is S0 or S3 is docked. A transition to (P3) from the state of (P1) occurs in a case in which the portable terminal 10 is activated (S0). (P3) is a docked state. In (P3), the ACPI state of the portable terminal 10 is S0 or S3, that is, the portable terminal 10 is turned on, and the cradle 20 is not in a state of being connected to an AC adapter. In this case, the GPIO1 signal is set to LOW (off), which indicates the power of USB is off. Further, the GPIO2 signal is set to LOW (off), which indicates that power off USB charging is disabled.

(P4) is an undocked state. In (P4), the ACPI state of the portable terminal 10 is the state of G3. Further, the cradle 20 is in a state of being connected to an AC adapter. In this case, the GPIO1 signal is set to HIGH (on), which indicates the power of USB is on. Further, the GPIO2 signal is set to be HIGH (on), which indicates that power off USB charging is enabled (activated). A transition to (P2) from the state of (P4) occurs in a case in which an AC adapter is disconnected (power loss). Conversely, a transition to (P4) from the state of (P2) occurs in a case in which an AC adapter is connected. A state transition of (P2)→(P4) is set as “Case (1)”.

A transition to (P5) from the state of (P4) occurs in a case in which a portable terminal 10 in which the ACPI state is G3, S5, or S4 is docked. A state transition of (P4)→(P5) is set as “Case (4)”. (P5) is a docked state. In (P5), the ACPI state of the portable terminal 10 is G3, S5, or S4, that is, the portable terminal 10 is turned off. Further, the cradle 20 is in a state of being connected to an AC adapter. In this case, the GPIO1 signal is set to HIGH (on), which indicates the power of USB is on. Further, the GPIO2 signal is set to be HIGH (on), which indicates that power off USB charging is enabled.

A transition to (P4) from the state of (P5) occurs in a case in which a portable terminal 10 is undocked. A state transition of (P5)→(P4) is set as “Case (2)”. A transition to (P1) from the state of (P5) occurs in a case in which an AC adapter of the cradle 20 is disconnected. Conversely, a transition to (P5) from the state of (P1) occurs in a case in which an AC adapter of the cradle 20 is connected. A state transition of (P1)→(P5) is set as “Case (7)”.

A transition to (P6) occurs in a case in which a portable terminal 10 in the docked state of (P5) is activated (S0). A transition to (P6) from the state of the cradle 20 alone in (P4) occurs in a case in which a portable terminal 10 in which the ACPI state is S0 or S3 is docked. A state transition of (P5)→(P6) is set as “Case (6)”. A state transition of (P4)→(P6) is set as “Case (5)”.

(P6) is a docked state. In (P6), the ACPI state of the portable terminal 10 is S0 or S3. Further, the cradle 20 is in a state of being connected to an AC adapter. In this case, the GPIO1 signal is set to be HIGH (on), which indicates the power of USB is on, and the GPIO2 signal is set to be LOW (off), which indicates that power off USB charging is disabled.

A transition to (P4) from the state of (P6) occurs when the portable terminal 10 is undocked, and power off USB charging becomes enabled (that is, the GPIO2 signal is HIGH). A state transition of (P6)→(P4) is set as “Case (2)”.

A transition to (P5) from the state of (P6) occurs when the ACPI state of the portable terminal 10 becomes G3, S5, or S4, and power off USB charging becomes enabled. A state transition of (P6)→(P5) is set as “Case (3)”

A transition to (P3) from the state of (P6) occurs when an AC adapter of the cradle 20 is disconnected. Conversely, a transition to (P6) from the state of (P3) occurs when an AC adapter of the cradle 20 is connected.

<Cases (1) and (7)>

First, GPIO control timings of “Case (1)”, which illustrates a state transition of (P2)→(P4), and “Case (7)” of a state transition of (P1)→(P5) will be described with reference to FIG. 8A.

In Case (1) and Case (7), power off USB charging changes from disabled to enabled. In other words, the cradle microcomputer 26 controls the GPIO2 signal to be HIGH in both a case in which a state transition of (P2)→(P4) occurs and a case in which a state transition of (P1)→(P5) occurs.

When the GPIO1 signal for power off USB charging is set to HIGH, as illustrated in FIG. 6B, first, the GPIO2 signal changes from LOW to HIGH ((a-1)). Thereafter, the GPIO1 signal changes from LOW to HIGH ((a-2)). As a result of this, it is possible to suppress a USB device from being recognized in an unstable docked state by stopping activation of the USB hub 34 and the USB switch 35 before power is supplied to a VBUS.

<Case (2)>

Next, GPIO control timing of “Case (2)”, which illustrates state transitions of (P6)→(P4) and (P5)→(P4) will be described with reference to FIG. 8B. In Case (2), the GPIO2 signal is temporarily controlled to be LOW when the portable terminal 10 and the cradle 20 are undocked in the state transitions of (P6)→(P4) and (P5)→(P4).

In this case, as illustrated in FIG. 6A, the GPIO2 signal is controlled to be LOW ((b-2)) after the GPIO1 signal is first controlled to be LOW (FIG. 8 (b-1)).

In Case (2), power off USB charging attains an enabled state after the transition. Accordingly, after the GPIO2 signal is controlled to be LOW, as illustrated in FIG. 6B, the GPIO2 signal is controlled to be HIGH ((b-3)), and thereafter, the GPIO1 signal changes from LOW to HIGH ((b-4)).

<Case (3)>

Next, GPIO control timing of “Case (3)”, which illustrates a state transition of (P6)→(P5) will be described with reference to FIG. 8C. The GPIO1 signal becomes LOW ((c-1)) when the ACPI state of the portable terminal 10 becomes G3, S5, or S4 in the state transition of (P6)→(P5).

In Case (3), power off USB charging changes from disabled to enabled. Accordingly, after the GPIO1 signal is controlled to be LOW, the GPIO2 signal is controlled to be HIGH ((c-2)), and thereafter, the GPIO1 signal changes from LOW to HIGH ((c-3)).

<Case (4)>

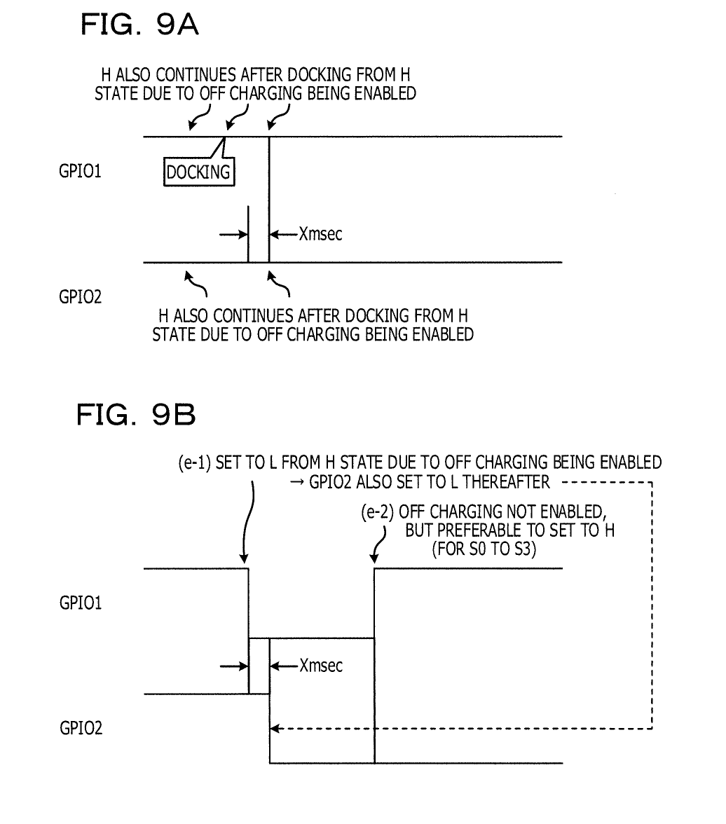

Next, GPIO control timing of “Case (4)”, which illustrates a state transition of (P4)→(P5) will be described with reference to FIG. 9A. In Case (4), since power off USB charging is retained as enabled, the GPIO2 signal is still retained as HIGH after docking ((d-1)). In a similar manner, the GPIO1 signal is also retained as HIGH after docking ((d-2)).

<Cases (5) and (6)>

Next, GPIO control timings of “Case (5)”, which illustrates a state transition of (P4)→(P6), and “Case (6)” of a state transition of (P5)→(P6) will be described with reference to FIG. 9B. In Case (5) and Case (6), power off USB charging changes from enabled to disabled. In this case, first, the GPIO1 signal changes from HIGH to LOW, and thereafter, the GPIO2 signal changes from HIGH to LOW ((e-1)). Thereafter, the GPIO1 signal becomes HIGH in order for the ACPI state of the portable terminal 10 to become S0 or S3 rather than to enable power off USB charging ((e-2)).

In the manner described above, in the present embodiment, combinations of the on and off timings of the GPIO1 signal and the GPIO2 signal illustrated in the state transition view are controlled by using the above-mentioned timings. More specifically, when it is detected that a connected portable terminal 10 is turned on during power supply from a USB terminal such as the USB hub 34 in a case in which power off USB charging is enabled, the GPIO1 signal is controlled to be HIGH after the GPIO2 signal is controlled to be LOW in a state in which the GPIO1 signal is controlled to be LOW. When it is detected that a portable terminal 10 turned on is connected to the cradle 20 during power supply from a USB terminal such as the USB hub 34 in a case in which power off USB charging is enabled, the GPIO1 signal is controlled to be HIGH after the GPIO2 signal is controlled to be LOW. In the above-mentioned manner, the GPIO1 signal is controlled to be LOW prior to the “GPIO1 signal being controlled to be HIGH after the GPIO2 signal is controlled to be LOW”.

During activation of power off USB charging, the GPIO2 signal is controlled to be HIGH prior to the “GPIO1 signal being controlled to be HIGH”. As a result of this, during activation of power off USB charging, it is possible to suppress a USB device from activating due to unstable docking connection information.

As a result of the GPIO1 signal and the GPIO2 signal being controlled by using a correct control sequence in this manner, according to a system of the present embodiment, the power off USB charging notification portion 42 performs notification of detection when it is detected that a connected portable terminal 10 is turned on while supplying power to a USB terminal, and a portable terminal 10 turned on is connected to the cradle 20. The USB power supply control portion 41 supplies power to a VBUS after power supply from a USB terminal is stopped in accordance with the notification of detection. As a result of this, it is possible to correctly recognize a USB device on the portable microcomputer 16 side. It is possible to enable the power off USB charging function without a USB device being activated in an unstable connection state of a USB signal.

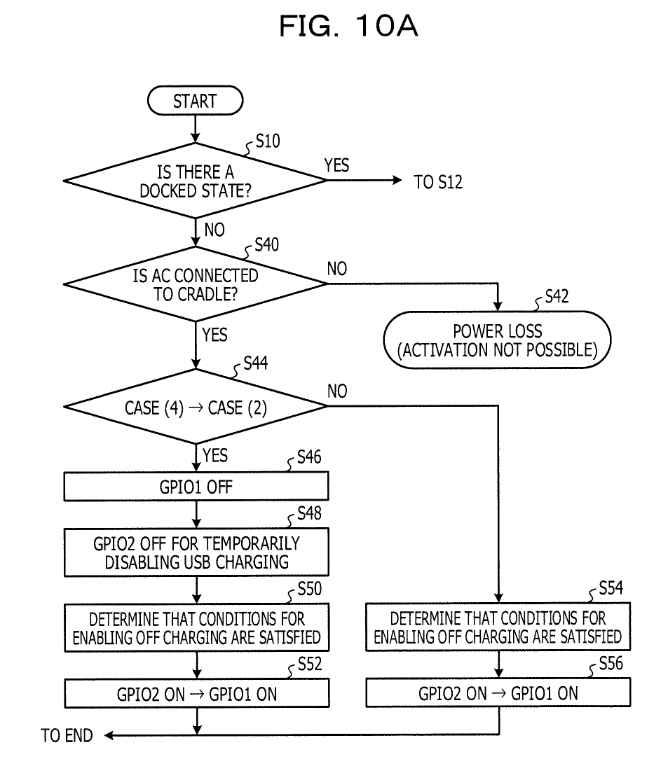

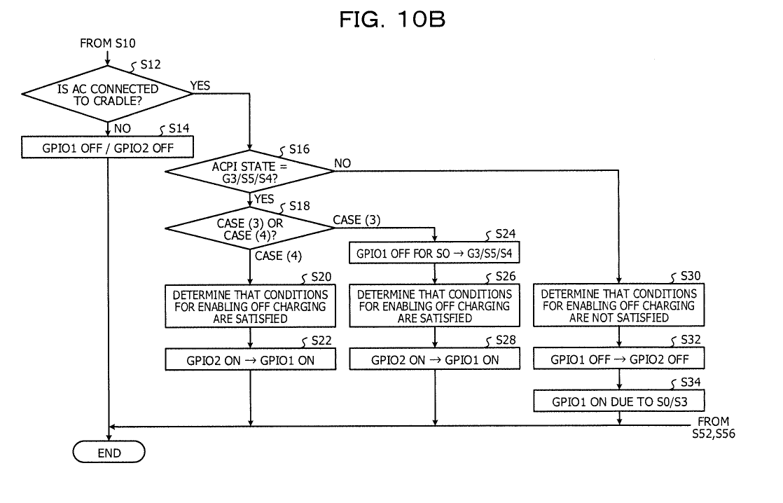

Lastly, a GPIO signal control process according to the present embodiment will be described with reference to FIGS. 10A and 10B. FIGS. 10A and 10B are flowcharts that illustrate an example of a GPIO signal control process according to the present embodiment. When the present process is started, as illustrated in FIG. 10A, the detection portion 8 detects whether or not there is a docked state in which the coupling portions 3 and 4 are coupled (S10). The process proceeds to S12 illustrated in FIG. 10B in a case in which it is determined that there is a docked state, and the process proceeds to S40 in a case in which it is determined that there is not a docked state.

In S12, the determination portion 9 determines whether or not an AC adapter of the cradle 20 is connected.

In a case in which it is determined that an AC adapter of the cradle 20 is not connected, there is an undocked state, and power is not supplied from an AC adapter. Therefore, the USB power supply control portion 41 and the power off USB charging notification portion 42 set the GPIO1 signal and the GPIO2 signal off (S14), and the present process is finished.

On the other hand, in a case in which it is determined that an AC adapter of the cradle 20 is connected in S12, the determination portion 9 determines whether the ACPI state of the portable terminal 10 is any one of G3, S5, or S4 (S16). In a case in which it is determined that the ACPI state is any one of G3, S5, or S4, the determination portion 9 determines a state transition of either Case (3) or Case (4) (S18).

In a case in which it is determined that it is Case (4), the determination portion 9 determines that conditions for enabling of power off USB charging are satisfied (S20). Accordingly, the power off USB charging notification portion 42 controls the GPIO2 signal to be HIGH. Thereafter, the USB power supply control portion 41 controls the GPIO1 signal to be HIGH (S22: refer to FIG. 9A), and the present process is finished.

On the other hand, in a case in which it is determined that it is Case (3) in S18, power off USB charging changes from disabled to enabled. Accordingly, as a result of the ACPI state changing from S0 to G3, S5, or S4, the USB power supply control portion 41 controls the GPIO1 signal to be LOW (S24: refer to FIG. 8C). Next, the determination portion 9 determines that conditions for enabling of power off USB charging are satisfied (S26). As a result of this, the power off USB charging notification portion 42 controls the GPIO2 signal to be HIGH. Thereafter, the USB power supply control portion 41 controls the GPIO1 signal from LOW to HIGH (S28), and the present process is finished.

In a case in which it is determined that the ACPI state of the portable terminal 10 is not any of G3, S5, or S4 in S16, the determination portion 9 determines that conditions for enabling of power off USB charging are not satisfied (S30). Accordingly, the USB power supply control portion 41 controls the GPIO1 signal to be LOW. Further, the power off USB charging notification portion 42 controls the GPIO2 signal to be LOW (S32). Next, since the ACPI state of the portable terminal 10 is either S0 or S3, the USB power supply control portion 41 controls the GPIO1 signal to be HIGH (S34), and the present process is finished. As a result of this, after power is supplied to the cradle 20, it is possible to restart power supply from a USB terminal.

In a case in which it is detected that there is not a docked state in S10, the determination portion 9 determines whether or not an AC adapter of the cradle 20 is connected (S40). In a case in which it is determined that an AC adapter of the cradle 20 is not connected, the cradle 20 is in a state in which activation is not possible due to power loss (S42).

In a case in which it is determined that an AC adapter of the cradle 20 is connected in S40, the determination portion 9 determines whether or not the state transitioned from Case (4) to Case (2) (S44).

In a case in which it is determined that the state has transitioned from Case (4) to Case (2), since there is an undocked state, power supply to a VBUS is stopped. Further, the USB power supply control portion 41 controls the GPIO1 signal to be LOW (S46: refer to FIG. 8B). Next, since power off USB charging is temporarily disabled, the power off USB charging notification portion 42 controls the GPIO2 signal to be LOW (S48).

Next, the determination portion 9 determines that conditions for enabling of power off USB charging are satisfied (S50). As a result of this, after the power off USB charging notification portion 42 has controlled the GPIO2 signal to be HIGH, the USB power supply control portion 41 controls the GPIO1 signal to be HIGH (S52), and the present process is finished.

In a case in which it is determined that a state transition from Case (4) to Case (2) was not performed in S44, Case (1) or Case (5)→Case (2) is determined. In this case, the determination portion 9 determines that conditions for enabling of power off USB charging are satisfied (S54). As a result of this, the power off USB charging notification portion 42 controls the GPIO2 signal to be HIGH. Thereafter, the USB power supply control portion 41 controls the GPIO1 signal to be HIGH (S56), and the present process is finished.

If a portable terminal 10 turned on is connected to the cradle 20 or a connected portable terminal 10 is activated during the activation of power off USB charging, that is, when power supply from a USB terminal of the USB hub 34, or the like, is being performed in a case in which a portable terminal 10 is not connected or a connected portable terminal 10 is turned off, there are cases in which failure occurs in a process of connection as a result of a power sequence fault occurring between a host controller and a USB hub or between a switch and a USB device.

In contrast to this, in the manner described above, according to a system of the present embodiment, in a case of transitioning from an activated state of power off USB charging to a state in which it is preferable to correctly recognize a USB device, it is possible to temporarily stop power supply from a USB terminal, and subsequently release resetting of a USB hub, or the like, to set an activation-capable state. Thereafter, power supply from a USB terminal is restarted, and a connection process of a USB host controller on the portable terminal 10 already turned on and a USB device on the cradle 20 is started. In this manner, as a result of realizing an ideal power sequence between the cradle microcomputer 26 and a USB device, it is possible to correctly recognize a USB device on the portable microcomputer 16 side.

As a result of setting to a state in which the USB hub 34 and the USB switch 35 are not activated during the activation of power off USB charging, it is possible to enable a function of power off USB charging without a USB device being activated in an unstable connection state of a USB signal.

An extension device, a system, and a program have been described by using the above-mentioned embodiments, but the extension device, the system, and the program according to the present disclosure are not limited to the embodiments, and various modifications and improvements are possible within the range of the present disclosure. In a case in which there are a plurality of the above-mentioned embodiments and modification examples, combination thereof is possible within a non-contradictory range.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a processor included in an extension device, the control method comprising:
executing power supply to another device via a connector using a battery provided in the extension device while power supply to the extension device is not executed;
stopping power supply to the other device when it is detected that a terminal device coupled to the extension device and different from the another device is turned on, or that the terminal device turned on is coupled to the extension device; and
starting power supply to the extension device while power supply to the other device is stopped.

2. The control method according to claim 1, further comprising
restarting power supply to the other device when power supply to the extension device is started.

3. The control method according to claim 2, further comprising
receiving, from the terminal device while power supply to the other device is executed, a notification indicating that the terminal device is turned on, or that the terminal device turned on is coupled to the extension device.

4. The control method according to claim 1,
wherein the stopping includes stopping output of power from a power circuit by transmitting a first signal to the power circuit.

5. The control method according to claim 4,
wherein the extension device includes a relay device connected between the terminal device and the other device, and
the executing of power supply to the other device includes controlling the relay device not to be activated by transmitting a second signal to the relay device.

6. The control method according to claim 5,
wherein the relay device is a switching hub or a switch.

7. The control method according to claim 1,
wherein the connector is a universal serial bus (USB) connector.

8. An extension device comprising:
a connector; and
a processor coupled to the connector and configured to:
execute power supply to another device via a connector using a battery provided in the extension device while power supply to the extension device is not executed;
stop power supply to the other device when it is detected that a terminal device coupled to the extension device and different from the another device is turned on, or that the terminal device turned on is coupled to the extension device; and
start power supply to the extension device while power supply to the other device is stopped.

9. The extension device according to claim 8, wherein the processor is configured to
restart power supply to the other device when power supply to the extension device is started.

10. The extension device according to claim 9,
wherein the processor is configured to receive, from the terminal device while power supply to the other device is executed, a notification indicating that the terminal device is turned on, or that the terminal device turned on is coupled to the extension device.

11. The extension device according to claim 8,
wherein the processor is configured to stop output of power from a power circuit by transmitting a first signal to the power circuit.

12. The extension device according to claim 11,
wherein the extension device includes a relay device connected between the terminal device and the other device, and
the executing of power supply to the other device includes controlling the relay device not to be activated by transmitting a second signal to the relay device.

13. The extension device according to claim 12,
wherein the relay device is a switching hub or a switch.

14. The extension device according to claim 8,
wherein the connector is a universal serial bus (USB) connector.

15. A non-transitory computer-readable recording medium storing a program that causes a processor included in an extension device to execute a process, the process comprising:
executing power supply to another device via a connector using a battery provided in the extension device while power supply to the extension device is not executed;
stopping power supply to the other device when it is detected that a terminal device coupled to the extension device and different from the another device is turned on, or that the terminal device turned on is coupled to the extension device; and
starting power supply to the extension device while power supply to the other device is stopped.
